(19) United States
(12) Patent Application Publication
(10) Pub. No.: US 2011/0215141 A1
(43) Pub. Date: Sep. 8, 2011

(54) APPARATUS, METHOD, AND SYSTEM FOR FACILITATING SWIPED MAGNETIC CARD-PRESENT FINANCIAL TRANSACTIONS USING ANY MOBILE TELEPHONE

(76) Inventor: RYAN P. MALLOY, Meridian, ID (US)

(21) Appl. No.: 12/965,916

(22) Filed: Dec. 12, 2010

Related U.S. Application Data
(60) Provisional application No. 61/285,980, filed on Dec. 12, 2009.

(51) Int. Cl. G06Q 40/00

(52) U.S. Cl. 235/379

(57) ABSTRACT

The present invention relates generally to financial processing systems. Specifically, this invention relates to mobile transaction processing utilizing existing voice network infrastructure and installed handsets. In a preferred embodiment, a payment card is swiped through a card-reader apparatus that is adapted to transmit data to a central processing system, via the handset. The system also interacts with the financial network in order to complete financial transactions. The system then passes the reply, if any from the financial network. Responses from the caller or apparatus may then be passed back to the system. This process repeats itself until all data is gathered or the call is terminated.

### CROSS-REFERENCE TO RELATED APPLICATIONS

This application claims benefit of the filing date of U.S. Provisional Patent Application No. 61/285,980 filed on Dec. 12, 2009.

### TECHNICAL FIELD AND INDUSTRIAL APPLICABILITY OF THE INVENTION

This invention relates to the exchange of currency via electronic means. The present invention relates particularly to using the existing wireless voice telephone network infrastructure and handsets to complete the transaction attempt.

### BACKGROUND OF THE INVENTION

My research efforts have been unable to locate a method, system, and apparatus that exists with the ability to collect and process data contained on a magnetic stripe bank card, collected by means of card swipe, using any common wireless telephone, without requiring an application to be executed on the handset.

Add-on magnetic card readers exist for certain mobile phones. Each make and model of phone supported typically requires a unique hardware design, and a proprietary software application must be installed on the phone. A data plan is also required. Certain phone models lack external interfaces to connect a card reader, precluding the phone from processing transactions.

### BRIEF SUMMARY OF THE INVENTION

The present disclosure provides a novel way to complete a transaction by transmitting the data encoded on the magnetic stripe. The data is converted to audio, which is relayed though any phone, wired or wireless, capable of connecting to a predetermined destination to transmit and receive “spoken voice” quality audio, or other supported protocol via a voice network to a Processing Center. The present disclosure utilizes critical voice network protocols such as dual tone multi-frequency (DTMF) tones, and cellular text telephone modem (CTM) to transmit data. This provides comprehensive compatibility with any ordinary mobile telephone and voice network. A variety of well known interfaces can be used to facilitate communication between the card reader and telephone, including but not limited to, built-in audio transducers, wired headset connection, and Bluetooth® wireless technology.

In order to use the invention, no additional software is required to be installed on the telephone that is utilizing the card reader apparatus. The remote processing center translates and routes communications between external systems, the caller, and card-reader apparatus. A reply is passed to the caller according to stored preferences. A receipt can also be generated and sent to interested parties by the processing center.

### BRIEF DESCRIPTION OF THE SEVERAL VIEWS OF THE DRAWING

FIG. 1 describes the system

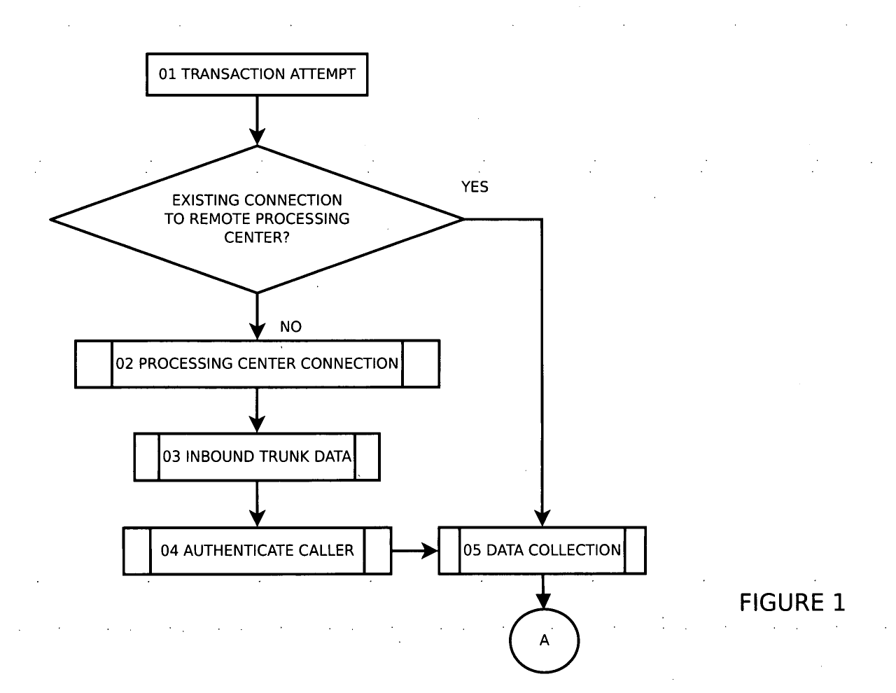

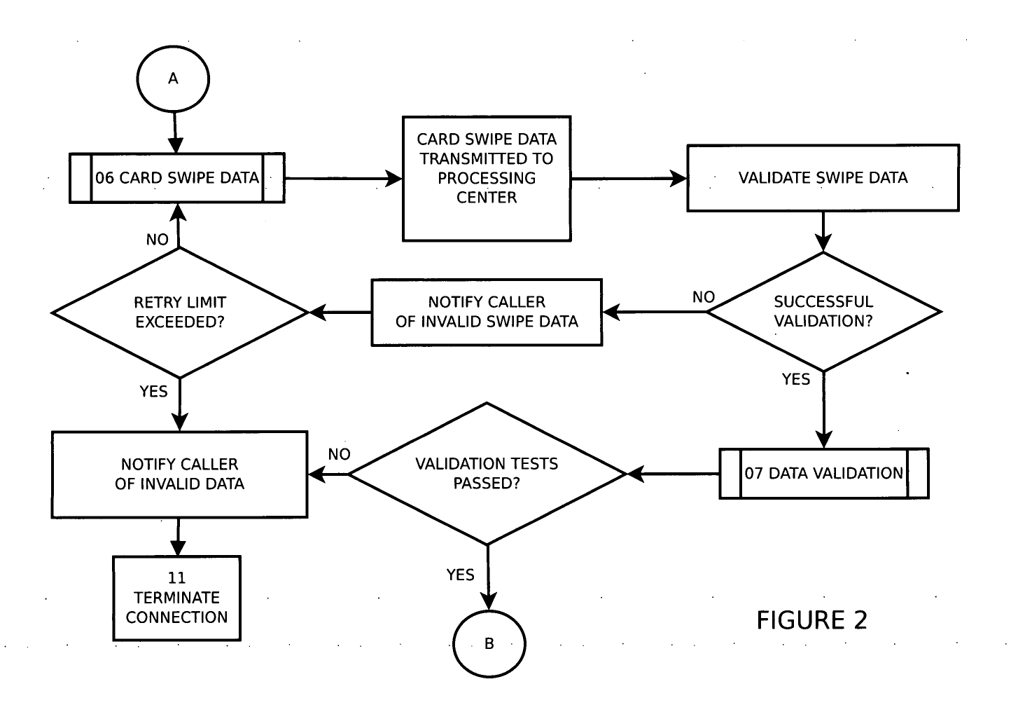

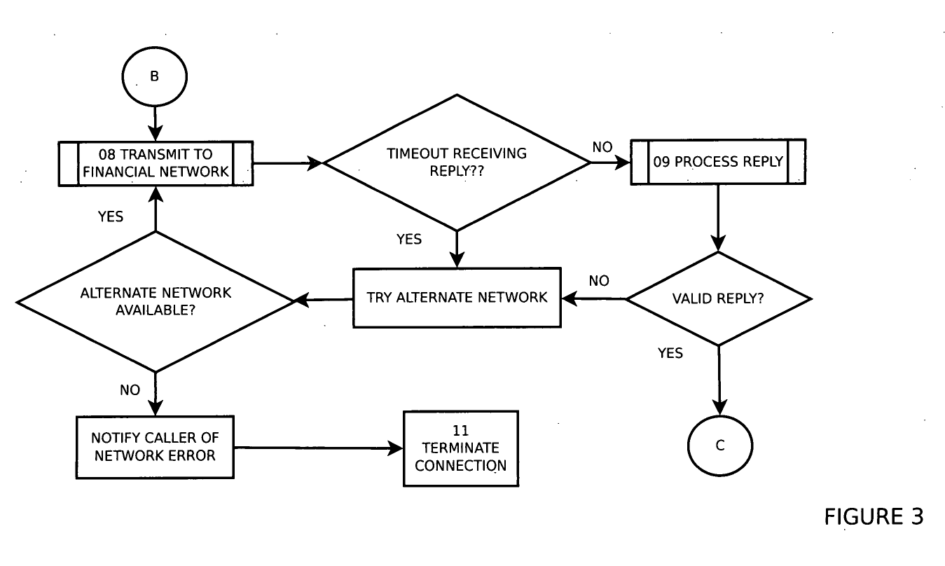

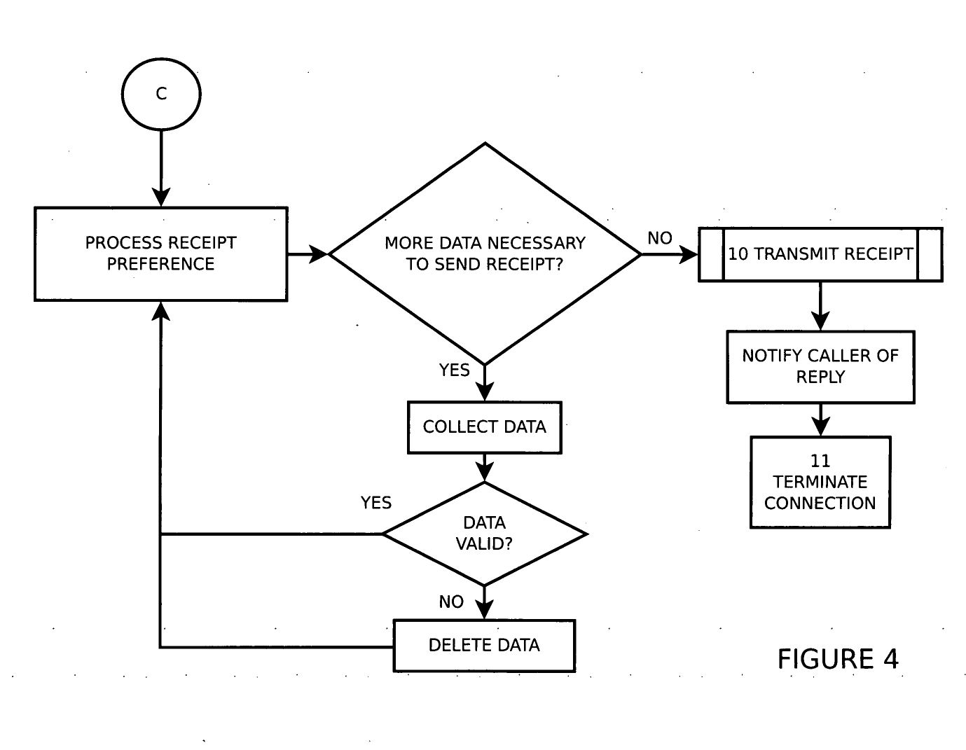

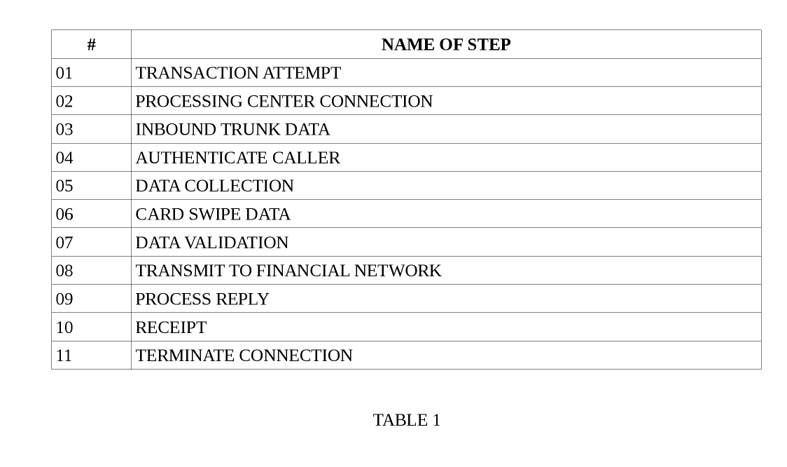

TABLE 1 is a table outlining the steps referenced in FIG. 1.

### DETAILED DESCRIPTION OF THE INVENTION

The process preferably begins at the step of 01 TRANSACTION ATTEMPT and ends at the step of 11 TERMINATE CONNECTION. As shown in the diagram FIG. 1, step of 01 TRANSACTION ATTEMPT occurs before step of 02 PROCESSING CENTER CONNECTION, which preferably occurs before the step of 03 INBOUND TRUNK DATA, and so forth. However the order of many of these steps may be changed. By way of example but not in limitation, the step of 05 DATA COLLECTION may happen before the step of 04 AUTHENTICATE CALLER or during or before any of the steps from 02 PROCESSING CENTER CONNECTION, to step 10 RECEIPT.

In the step of 01 TRANSACTION ATTEMPT, the payer presents a bankcard to facilitate a financial transaction. The card is swiped through a card-reader apparatus that is adapted to transmit data to a central processing system, via the handset.

In the step of 02 PROCESSING CENTER CONNECTION the caller or apparatus attempts to establish a connection to the processing center via a voice network. A connection must be established with the processing center or the attempt fails. In the event of failure the caller or apparatus can then attempt a retry to the same or an alternate destination address. Multiple processing centers may respond to the same destination address, such that in the event of a failure the caller can simply retry the previous destination address with a different outcome possible.

In the step 03 INBOUND TRUNK DATA the processing center collects the data available about the incoming call, such as, but not limited to, time of call, calling party identification, or other data available from the phone network.

In the step 04 AUTHENTICATE CALLER, the processing center may, depending on configuration, prompt the caller to assert their identity using a secret phrase, and a optionally a unique user name if one is not available or implied from the data collected in step 03 INBOUND TRUNK DATA. The user name and secret phrase may be collected by means of the microphone, telephone keypad, or other external hardware, such as, but not limited to, magnetic stripe reader described in the step 06 CARD SWIPE DATA, biometric scanner, or audio sample. A limited number of retries are permitted in the event of authentication failure. If all permitted retries are exhausted, the connection is terminated.

In the step 05 DATA COLLECTION, the processing center audibly prompts for the amount of the transaction, and collects any other desired data regarding the transaction, or the parties involved.

In the step 06 CARD SWIPE, the processing center accepts card swipe data. The caller uses an apparatus comprised of a magnetic stripe reader and supporting circuitry to convert the data encoded on the stripe into a series of tones suitable for transmission on a standard voice network. It may also add additional data, such as, but not limited to: a unique identifier, and/or other collected or stored data. Preferably the apparatus utilizes critical voice network protocols to ensure comprehensive compatibility. Examples of critical voice network protocols include spoken voice, dual tone multi-frequency (DTMF) and cellular text telephone modem (CTM). The processing center uses one or more redundancy checks to validate the card stripe data¹. In the event of redundancy check failure, a limited number of retry attempts are permitted, preferably less than 10. At each retry the caller attempts to provide the card swipe data and the step 06 CARD SWIPE commences again to process the data, unless all permitted retries are exhausted without a successful redundancy check. If all permitted retries are exhausted, the caller is notified and the connection is terminated. 1 Redundancy checks include but are not limited to, cyclic-redundancy-check (CRC), longitudinal redundancy check (LRC).

In the step 07 DATA VALIDATION, the processing center applies well known algorithms and proprietary algorithms to validate the data collected regarding the transaction. This is done for a variety of reasons including, but not limited to: fraud detection, data validation and to ensure all necessary data is available to transmit a request to the proper financial network.

In the step 08 TRANSMIT TO FINANCIAL NETWORK, the processing center constructs a packet in the proper format for the chosen financial network, comprised of applicable data validated in step 07 DATA VALIDATION, as well as any other data required. An attempt is made to transmit the packet to the financial network.

In the step 09 PROCESS REPLY, the processing center processes the reply from the step 08 TRANSMIT TO FINANCIAL NETWORK. A limited number of retry attempts, as well as a timeout are used in the event of transmission error, or reply error. If the retry attempts are exhausted and other networks are available to process the transaction request, the processing center will, if necessary, reconstruct the packet and attempt transmission to the financial network. The aforesaid “transmit and wait for reply or timeout” logic will continue until all possible networks are tried or a valid response is received. If no valid response is received or timeout occurs and no other possible networks exist, the caller is notified and the connection is terminated.

In the step 10 RECEIPT the remote processing center checks stored preferences for the transaction, and related parties. If necessary the caller will be prompted for more data, including, but not limited to, a telephone number, or short-message-service (SMS) destination code. The processing center will validate the data and transmit the receipt. The connection will then be terminated.

1. I claim to have invented a system to attempt a financial transaction wherein the buyer provides financial account information by a means of swiping and reading the account data as intended by the card issuer comprising:
(a) an apparatus to gather credit card magnetic swipe data; capable of communicating the data to a central computer network utilizing the existing wireless voice infrastructure, providing a broad range of handsets additional abilities comprising:
i. a method of reliably communicating the data required to process the financial transaction, to a central computer network via existing wireless voice telephone infrastructure;
ii. a method of receiving the transported data as well as collecting additional data, in an attempt to form and transmit a data packet or packets to a predetermined destination on the financial network dictated by the card issuer; and
iii. a method of communicating a response to the transaction attempt, computed using logic and previously gathered data.

2. A system as claimed in claim 1 in which the communication method utilizes at least one standard protocol comprising:
(a) spoken voice,
(b) dual tone multi-frequency audio tones,
to provide comprehensive compatibility with the existing handsets carried by users and the voice networks servicing the handsets.
